(19) United States
(12) Patent Application Publication
(10) Pub. No.: US 2002/0002471 A1
(43) Pub. Date: Jan. 3, 2002

(54) Method of and system for implementing a business method conceived by a consumer by participation of consumers

(75) Inventor: Munetoshi Ono, HigashiKurume City (JP)

Correspondence Address: SUGHRUE MION ZINN,, MACPEAK & SEAS, PLLC, 2100 Pennsylvania Avenue, NW, Washington, DC, 20037, US

(73) Assignee: BRIDGESTONE CORPORATION

(21) Appl. No.: 09/888,377

(22) Filed: Jun. 26, 2001

(30) Foreign Application Priority Data
Jun. 27, 2000 (JP) 2000-193447

(51) Int. Cl. G06F 17/60

(52) U.S. Cl. 705/1

(57) ABSTRACT

This invention provides for a method of and a system for gathering business methods conceived by a consumer that coincide with a basic conception of a company, and then implementing the gathered business method as an executable method by discussion of the method via a communication network between consumers and the company. In this invention, an improved method that increases the added value of the core business method, is also implemented quickly and originally by discussion via a communication network between consumers and the company. The conceiver of the business method executed becomes at least one of a stockholder and a business partner of the company, and a predetermined proportion of the profit obtained by executing the method is shared with the conceiver of the method.

### BACKGROUND OF THE INVENTION

1. Field of the Invention

The present invention relates to a method of and a system for implementing a business method conceived by a consumer that coincides with a basic conception of a business method of a company, in particular, to a method of and a system for implementing the business method quickly and originally by active participation of consumers via a communication network in not only conceiving the business method but also implementing.

2. Discussion of the Related Art

A company dealing with developing merchandise, the production or sales of goods, or service presentation, before making a start on a new business or a business that improves or expands the existing business, generally conceives and discusses a new business method within the company. And, an original business method or a method matching with public demand generally leads to increased consumption or use of goods or services. However, a discussion only within the company generally results in a narrow and stereotyped business method, because of lack of experience of the company, the cost of manufacture and the ease of production, among many factors.

On the other hand, a consumer sometimes develops a suitable business method, such as an improved method for producing, shipping and/or using goods that he or she has experience using. Actually, the business method developed by the consumer is sometimes the best method for responding to the current fashion and demand.

Therefore, the company sometimes asks opinions of a plurality of people who are assumed to be consumers of the goods or services presented by the company, for example obtaining information by means of questionnaires about a certain trial product, and makes good use of the opinions to conceive a business method that corresponds with the demand. In the above case, however, an original business method can't be constructed, because the core business method is presented by the company, and the consumers only give impressions or wishes as to the presented business method.

Contests evaluating original business methods conceived by consumers or plans gathering original business methods conceived by consumers that coincide with the basic conception of the company are frequently carried out. In particular, utilizing a network such as the Internet quickly gathers a large amount of information on business methods conceived by various kinds of people. But, in these cases, the original business methods conceived by consumers generally lose originality when the practice of the method is started, because selecting and implementing the gathered business method is carried out only within the company and consumers don't take part in implementing the method.

### OBJECT AND SUMMARY OF THE INVENTION

It is therefore an object of the present invention to provide a method of implementing an original business method conceived by a consumer quickly and originally by active participation of consumers via a communication network in not only conceiving the business method but also implementing. The above object is achieved by a method of implementing a business method conceived by a consumer by participation of consumers in implementing the business method, comprising the steps of; gathering business methods conceived by consumers that coincide with a basic business method concept of a company; and discussing via a communication network at least one of the gathered business methods, between a conceiver of the business method and the company, in order to implement the business method as an executable method.

For the purpose of this invention, the word “the consumer” includes anyone who makes use of goods and service presented by the company, for example, an expert such as a management consultant and people of experience or academic standing, an employee of the company, an office worker, a housekeeper and a student, etc. And the term “the communication network” refers to the network making it possible to communicate between the company and the consumers and the consumers with one another. Examples of the communication networks are Internet, Intranet, PC communication network, telephone network, in particular Internet. The company and the consumers can connect each other via the communication network by suitable connecting means, for example, a PC, a telephone and a facsimile, etc. The term “the basic business method concept of the company” refers to a basis presented from the company as the point of departure in gathering the business methods, for example, “expanding the range of business”, “starting business in a new field”, “developing a new product” and “finding usage of the new material”. And the word “the conceiver” refers to the consumer who proposes the conceived business method.

Another object of this invention is to provide the method of increasing the added value of the method conceived by the consumer quickly and originally, further comprising the steps of, selecting one of the business methods implemented as the executable methods by discussing via the communication network, as a core method to be executed; opening to the public via a communication network the core method together with an announcement of gathering proposed business methods conceived by consumers that increase the added value of the core method; and gathering business methods conceived by consumers via a communication network that relate to the core method.

A further object of this invention is to provide the method of strengthening the competitive power of the business method continuously and expanding the business; further repeating the steps consisting of, selecting one of the business method implemented as an executable method which increases the added value of the core method by discussing via the communication network as an improved method to be executed; opening to the public via the communication network the improved method together with an announcement of gathering proposed business methods conceived by consumers that increase the added value of the improved method; gathering business methods conceived by consumers via a communication network that relates to the improved method; and discussing via the communication network at least one of the gathered business methods that relates to the improved method, between a conceiver of a business method that relates to the improved method and the company, in order to implement the business method as an executable method which increases the added value of the improved method.

A further object of this invention is to provide the method of increasing quality of the business methods conceived by consumers so that the methods are easily implemented to the point of being an executable method. This object is achieved by the method, wherein the conceiver of the executed method becomes at least one of a stockholder and a business partner of the company, and also by the method, wherein a predetermined proportion of profit obtained by executing the core method is shared with the conceiver of the executed method.

A still further object of this invention is to provide a system for implementing an original business method conceived by a consumer effectively.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a flow chart of a method of implementing a business method conceived by a consumer in accordance with the present invention.

FIG. 2 is a schematic drawing of a system for implementing a business method conceived by a consumer in accordance with the present invention.

FIG. 3 shows a discussion via Internet between a conceiver and a company.

FIG. 4 shows a discussion via Internet among a conceiver, a company and additional consumers.

FIG. 5 is a summary drawing showing a result of the present invention.

### DETAILED DESCRIPTION OF THE INVENTION

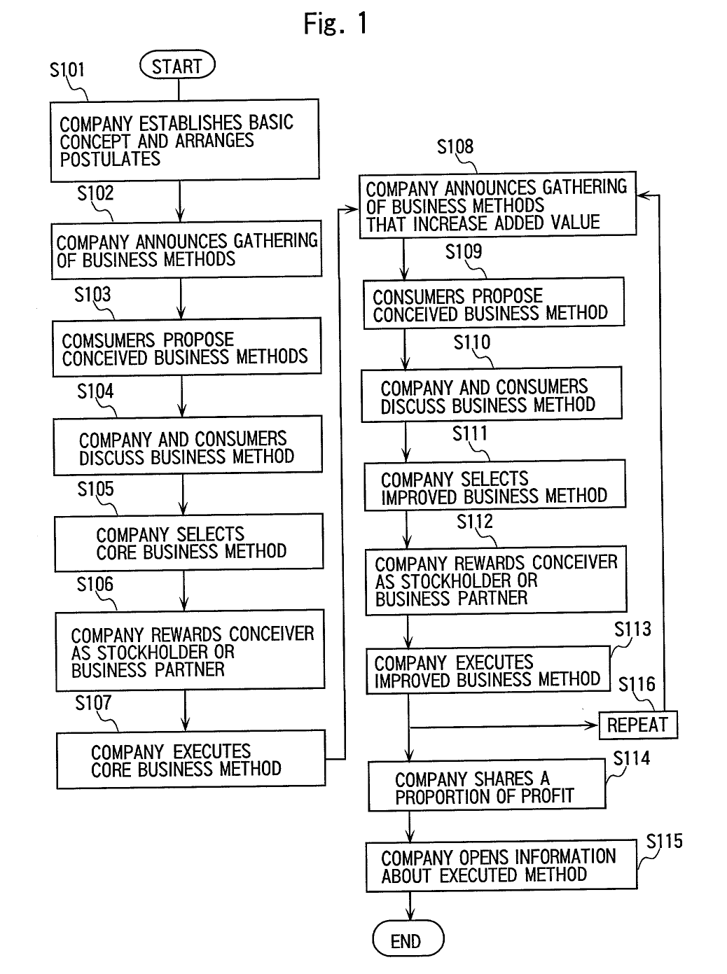

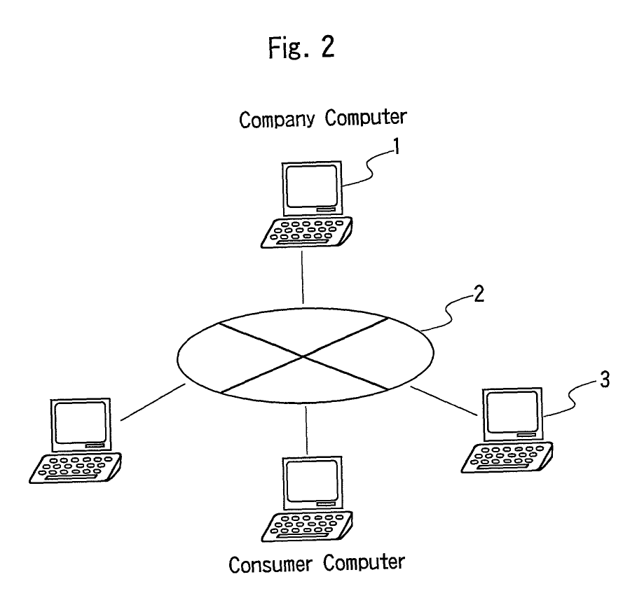

Preferred embodiments of the present invention and its advantages are best understood by referring now to FIG. 1 through 5 of the drawings. FIG. 1 shows the action of the method of implementing the business method of this invention, and FIG. 2 shows the construction of the system for implementing the business method of this invention. As known from FIG. 2, the system of this invention includes a computer of the company 1 and a computer of the consumer 3, and the computer of the company 1 and the computer of the consumer 3 are connected via Internet 2 as the communication network. The company and a plurality of consumers can communicate with one another via Internet 2.

As shown in FIG. 1, the company which plans to implement the business method conceived by the consumer, before gathering information about the business methods conceived, firstly establishes the basic conception of the business plan by the company, and arranges the postulates as a basis on which consumers conceive the business methods that coincide with the basic conception of the company (S101). The postulates, here, refer to the absolute requirements matching with the basic conception as the point of departure, for example “a business method concerning goods using newly developed material”, and “a business method utilizing the Internet”, etc.

Next, the company prepares the home page that describes gathering of the business methods, and opens the home page to consumers via Internet 2 from the computer of the company 1(S102). It is suitable that the home page has input sections for the information necessary to contact the conceiver, for example the name, the address, and e-mail address of the conceiver, and the information of the business method conceived, for example, the object of the method, the abstract of the method, a flow chart, and block diagrams, etc. Opening the above home page via Internet gives a quick and widespread announcement to various kinds of consumers. The usage of other media, for example newspapers, magazines, TV, at the same time can increase the effect of the announcement

The consumer who has read the home page, conceives the business method that coincides with the basic conception of the company and the postulates, then accesses the above home page via Internet 2 from consumer computer 3, and proposes the conceived business method by inputting the information of the business method to the input sections of the home page (S103). This leads to the quick and mass gathering of business methods that coincide with the basic conception of the company. The company can of course receive the application in writing.

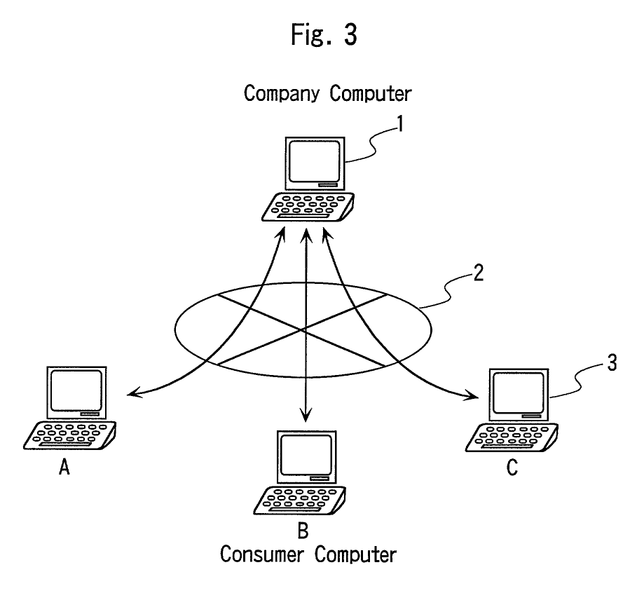

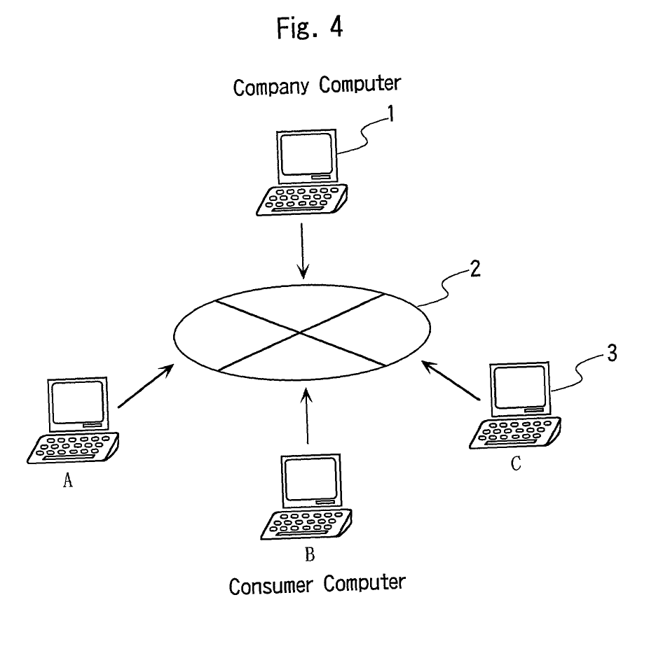

As to those business method which the company considers implementing, the company and the conceiver discuss the business method in order to modify it and implement it to an executable method. The discussion is carried out via Internet 2 between the company computer 1 and the consumer computer 3 (S104) in the embodiments of, for example, a bulletin board system, chat, and e-mail. The participants to the discussion are selected depending on confidentiality, potentiality and urgency of starting the business method, etc. The discussion may be carried out between the company and the conceiver as shown in FIG. 3, or additional consumers, such as experts in the field to which the discussed business method relates and the conceivers who have conceived similar business methods, can participate in the discussion as shown in FIG. 4. The experts in the field to which the discussed business method relates are, for example, a management consultant and people of experience or academic standing, etc. The discussion between the company and consumers results to implement the discussed business method originally, and the quick implementation of the business method and the quick startup of the business are possible by utilizing Internet 2. And, in the case that the suggestion of other consumers, other than the company and the conceiver is taken into consideration, the original and well-thought out business method can be implemented from various points of view. A discussion without using the Internet can be of course carried out, for example discussions in the form of a video conference meeting, a telephone meeting and communication via facsimiles.

If the discussed business method is implemented to the point of being an executable method by discussing via Internet, the company selects it as the core method to be executed (S105), and rewards the conceiver of the core method as a stockholder and/or a business partner of the company (S106). By rewarding the conceiver of the core method as a stockholder and/or a business partner of the company, the conceiver can directly take part in management of the company, and can receive benefit from healthy management of the company. This increases the gathering of potential business methods, increases quality of the gathered business methods, and increases quality of discussion between the company and the consumers. And, the company executes the business method based on the above core method (S107).

Next, the company plans to increase the added value of the core method. The company prepares the homepage describing the core method executed together with an announcement that it is gathering additional business methods conceived by consumers that increase the added value of the core method, and opens the homepage to the public via Internet 2 from the company computer 1 (S108). Opening the above home page via the Internet gives a quick and widespread announcement as in the case of gathering of the core methods. The usage of other media, for example newspapers, magazines, TV, at the same time can increase the effect of the announcement. By gathering the business methods that increase the added value of the basic method from consumers via the Internet, it is possible to implement and strengthen the core method quickly and originally.

The consumer who has read the above home page, conceives a business method that increases the added value of the core method, then accesses the above home page via Internet 2 from the consumer computer 3, and proposes the conceived business method (S109). This leads to the quick and mass gathering of business methods that increase the added value of the core method.

As to those business method which the company considers implementing, the company and the conceiver discuss the business method in order to modify it and implement it to the point of being an executable business method. The discussion is carried out via Internet 2 between the company computer 1 and the consumer computer 3 (S110). The participants to the discussion are selected depending on confidentiality, potentiality and urgency of starting the business method, etc. The discussion may be carried out between the company and the conceiver as shown in FIG. 3, or additional consumers, such as experts in the field to which the discussed business method relates, the conceivers who have conceived similar business methods and the conceiver of the core business method, can participate in the discussion as shown in FIG. 4. The discussion between the company and consumers leads to implementing the business method that increases the added value of the core method originally, and quick implementing the business method and quick startup of the business are possible by utilizing Internet 2.

If the discussed business method is implemented to the point of being an executable improvement to the business method by discussing via Internet 2, the company selects it as the improved method to be executed (S111), and rewards the conceiver of the improved method as a stockholder and/or a business partner of the company (S112). Rewarding the conceiver of the improved method as a stockholder and/or a business partner of the company increases gathering of proposed plans and implementing a well-thought improved method. The company executes the business method based on the above improved method (S113).

A predetermined proportion of the profit obtained by executing the core method or the improved method is shared with the conceiver of the core method or the improved method, or if desired, with the participants of the discussion (S114). Sharing of a proportion of the profit obtained by executing the method increases gathering of business methods which have the possibility of making a big profit, further increasing the quality of the gathered business methods, and further increasing the quality of discussing between the company and consumers. If a predetermined proportion of the profit obtained by executing the method is shared with the employee of the company who conceives the core method or the improved method, great encouragement is also given to the employees. At the same time, the company opens to the public via Internet 2 from the company computer 1 information about the executed business method, the conceiver of the method, the situation of executing the method, and the profit obtained by executing the method (S115). This crystallizes the circumstances from the time of gathering the business method to executing the method, therefore, the trust of the conceiver is given to the company. And, it is expected that the amount and quality of the business methods gathered from consumers increases. And continuously repeating the steps comprising of opening to the public via Internet 2 as to one of the business methods, gathering business methods conceived by consumers via Internet 2, discussing via Internet 2 the gathered business methods and selecting the business method implemented to the point of being an executable method as an improved method to be executed (S116), strengthens the competitive power of the core business method.

### EXAMPLE

The company A selling automative parts plans to gather business methods conceived by the consumer that coincide with “total car life support for making lives rich” as the basic concept of the company and “a method concerning the existing business” and “a method that utilizes the Internet” as the postulates, and to implement those together with consumers to the point of being an executable method. Next, the company A prepares the home page that has input sections for the name, the address, and e-mail address of the conceiver, and the object of the conceived method, the abstract of the method, a flow chart, and block diagrams as well as the announcement of gathering such proposed business methods from consumers, and opens the home page to consumers via the Internet from the company computer. The consumers B, C and D who have read the home page, conceive business methods that coincide with the above basic concept of the company and the postulates, and access the above home page via Internet 2 from each computer, and propose the business methods by inputting the information to the input sections. The company A selects the method conceived by the consumer B, “the method of mediating between the company A and consumers by delivering maintenance information to consumers”. The company A discusses via the Internet details of the contents and how to deliver, with the conceiver B and the system engineer E as the expert, in order to implement the method to the point of being an executable method, and then the company A executes the sufficiently implemented method. The company A rewards the conceiver B by making B as a business partner.

Next, the company A plans to increase the added value of the above method. The company prepares the homepage describing the outline of the method executed, that is, “the method of mediating between the company A and consumers by delivering maintenance information to consumers”, together with an announcement of gathering proposed business methods conceived by consumers that increase the added value of the above method, and opens the homepage to the public via the Internet from the company computer. The consumers F, G and H who have read the above home page, conceive business methods which increase the added value of the above method, access to the above home page via the Internet from each computer, and propose the conceived business methods. The company A selects the method conceived by the consumer F, “the method of searching for maintenance information delivering to consumers efficiently”. The company A discusses via the Internet how to search in detail, with the conceiver F and the system engineer E as the expert, in order to implement the method to the point of being an executable method, and the company A executes the sufficiently implemented method. The company A rewards the conceiver F as a business partner.

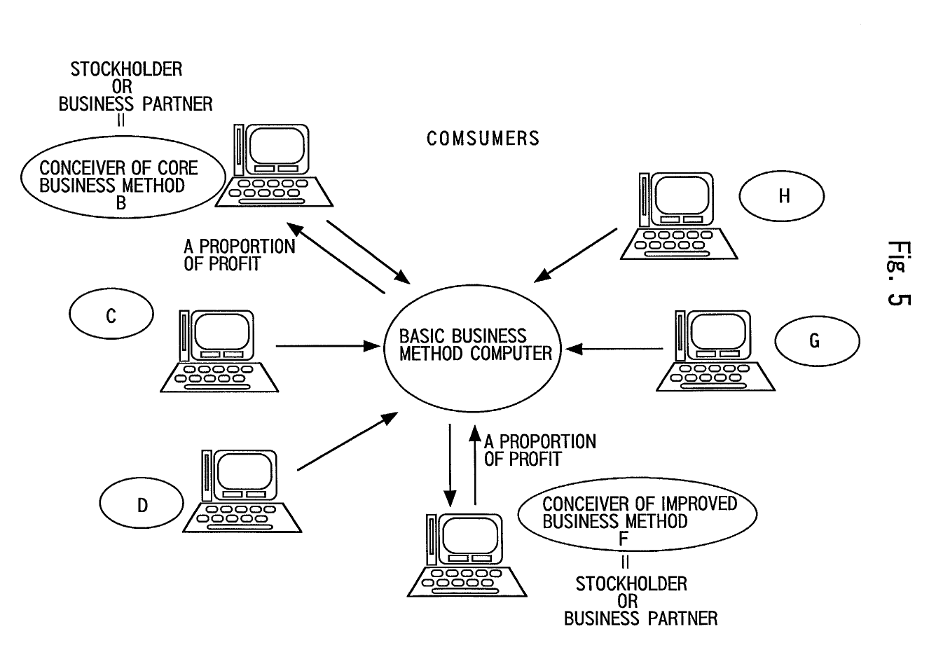

After one year from starting the method, the company A has better profit obtained by executing the methods conceived by B and F. So the company A shares, for example, 5% of the profit to B and 2% to F, and discloses to the public via the Internet as to the information containing the business methods executed, the name of B and F, the situation of executing the methods, and the profit obtained by executing the methods. FIG. 5 shows the summary drawing of the above example.

As explained above, the original and quick implementing of the core method and further the improved method is achieved, according to the method and the system of this invention. Therefore, continuous strengthening of the competitive power of the business method and expanding business are produced.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A method of implementing a business method conceived by a consumer by participation of consumers in implementing the business method, comprising the steps of,
gathering business methods conceived by consumers that coincide with a basic business method concept of a company; and
discussing via a communication network at least one of the gathered business methods, between a conceiver of the business method and the company, in order to implement the business method as an executable method.

2. The method as claimed in claim 1, wherein at least one additional consumer other than the conceiver, participates in the discussion via the communication network.

3. The method as claimed in claim 2, wherein the additional consumer is selected from among conceivers of similar business methods and experts in the business field to which the discussed business method relates.

4. The method as claimed in claim 1, further comprising the steps of,
selecting one of the business methods implemented as the executable methods by discussing via the communication network, as a core method to be executed;
opening to the public via a communication network the core method together with an announcement of gathering proposed business methods conceived by consumers that increase the added value of the core method; and
gathering business methods conceived by consumers via a communication network that relate to the core method.

5. The method as claimed in claim 4, wherein the conceiver of the core method becomes at least one of a stockholder and a business partner of the company.

6. The method as claimed in claim 4, wherein a predetermined proportion of profit obtained by executing the core method is shared with the conceiver of the core method.

7. The method as claimed in claim 4, wherein a predetermined proportion of profit obtained by executing the core method is shared with the additional consumer who has participated in the discussion.

8. The method as claimed in claim 4, further comprising the step of publicly opening via a communication network information containing the core method, the conceiver of the core method, how the core method was executed, and profit obtained by executing the core method.

9. The method as claimed in claim 4, further comprising the step of discussing via the communication network at least one of the gathered business methods that relate to the core method, between a conceiver of the business method that relate to the core method and the company, in order to implement the business method as an executable method that increases the added value of the core method.

10. The method as claimed in claim 9, wherein at least one additional consumer other than the conceiver of the business method that relate to the core method, participates via the communication network in the discussion of the business method that relate to the core method.

11. The method as claimed in claim 10, wherein the additional consumer who participates in the discussion of the business method that relate to the core method, is selected from among the conceiver of the core method, conceivers of the similar business methods, and experts in the business field to which the discussed business method relates.

12. The method as claimed in claim 9, further repeating the steps consisting of,
selecting one of the business method implemented as an executable method which increases the added value of the core method by discussing via the communication network as an improved method to be executed;
opening to the public via the communication network the improved method together with an announcement of gathering proposed business methods conceived by consumers that increase the added value of the improved method;
gathering business methods conceived by consumers via a communication network that relates to the improved method; and
discussing via the communication network at least one of the gathered business methods that relates to the improved method, between a conceiver of a business method that relates to the improved method and the company, in order to implement the business method as an executable method which increases the added value of the improved method.

13. The method as claimed in claim 12, wherein at least one additional consumer other than the conceiver of the business method that relate to the improved method, participates via the communication network in the discussion of the business method that relate to the improved method.

14. The method as claimed in claim 12, wherein the conceiver of the improved method becomes at least one of a stockholder and a business partner of the company.

15. The method as claimed in claim 12, wherein a predetermined proportion of profit obtained by executing the improved method is shared with the conceiver of the improved method.

16. The method as claimed in claim 12, further comprising the step of opening to the public via the communication network information containing the improved method, the conceiver of the improved method, how the improved method was executed, and profit obtained by executing the improved method.

17. The method as claimed in claim 12, wherein the communication network is Internet.

18. A system for implementing a business method conceived by a consumer by participation of consumers in implementing the business method, comprising means for discussing via a communication network at least one business methods that coincide with a basic business method concept of a company, in order to implement the business method as an executable core method and as an executable improved method.

19. The system as claimed in claim 18, further comprising means for gathering business methods conceived by consumers via the communication network.

20. The system as claimed in claim 19, further comprising means for opening to the public via the communication network as to information containing the executed business method, after selecting one of the implemented business method by discussing via the communication network as the business method to be executed.
